(19) United States
(12) Patent Application Publication
(10) Pub. No.: US 2026/0088591 A1
(43) Pub. Date: Mar. 26, 2026

(54) SPARK-PLUG WIRES FOR VEHICLE IGNITION SYSTEM

(71) Applicant: FORD GLOBAL TECHNOLOGIES, LLC, Dearborn, MI (US)

(72) Inventors: Robert HUMPHREY, Saline, MI (US); Brian THOMPSON, Bremen, IN (US)

(21) Appl. No.: 18/894,930

(22) Filed: Sep. 24, 2024

(51) Int. Cl. H01T 13/36; F02P 15/00

(52) U.S. Cl. CPC H01T 13/36; F02P 15/00

(57) ABSTRACT

A spark-plug wire includes a boot of electrically insulating material. The boot includes a wire bore, a spark-plug bore defining a terminal pocket adjacent to an end of the wire bore, and a retainer extending radially inward from a sidewall of the wire bore and defining a radial wall of the terminal pocket. A terminal is disposed in the terminal pocket and configured to connect with a spark plug when received in the spark-plug bore. The radial wall of the retainer is configured to engage with the terminal to inhibit movement of the terminal. A wire is disposed in the wire bore and is electrically connected to the terminal.

### TECHNICAL FIELD

This disclosure relates to internal-combustion engines and more particularly to spark-plug wires.

### BACKGROUND

An internal-combustion engine may include spark ignition. The spark ignition is provided by spark plugs that are positioned in combustion chambers of the engine. The spark plug includes first and second electrodes that are spaced apart from each other to produce an electric arc (spark) when current is supplied to the spark plug by an ignition system. Current is supplied to the spark plugs at select timing to ignite the air-fuel mixture within the combustion chamber according to engine timing. Spark-plug wires connect the spark plugs to the ignition system. The wire includes a boot configured to couple with the spark plug and a cable portion that extends from the boot to connect with a component of the ignition system, such as a coil pack or distributor.

### SUMMARY

According to one embodiment, a spark-plug wire includes a boot of electrically insulating material. The boot includes a wire bore, a spark-plug bore defining a terminal pocket adjacent to an end of the wire bore, and a retainer extending radially inward from a sidewall of the wire bore and defining a radial wall of the terminal pocket. A terminal is disposed in the terminal pocket and configured to connect with a spark plug when received in the spark-plug bore. The radial wall of the retainer is configured to engage with the terminal to inhibit movement of the terminal. A wire is disposed in the wire bore and is electrically connected to the terminal.

According to another embodiment, a spark-plug wire includes a boot defining a terminal pocket and a wire extending into the boot and including a terminal disposed within the terminal pocket. The terminal pocket includes a radially extending wall configured to engage with the terminal to inhibit movement of the terminal, wherein the radially extending wall circumferentially extends less than 180 degrees around the terminal pocket.

According to yet another embodiment, a vehicle ignition system includes a spark-plug wire having a boot of electrically insulating material with a wire bore and a spark-plug bore defining a terminal pocket adjacent to an end of the wire bore. A retainer extends radially inward from a sidewall of the wire bore and defines a radial wall. A terminal is disposed in the terminal pocket. The radial wall of the retainer is configured to engage with the terminal to inhibit movement of the terminal. A wire is disposed in the wire bore and is electrically connected to the terminal. A spark plug is received in the spark-plug bore and is connected to the terminal.

### BRIEF DESCRIPTION OF THE DRAWINGS

FIG. 1 is a schematic diagram of an engine shown in cross-section.

FIG. 2 is a side view of a spark-plug assembly shown in partial cutaway.

FIG. 3 is a perspective view of a spark plug wire of the spark-plug assembly.

FIG. 4A is a partial side view of a boot of the spark plug wire without the electrical components installed.

FIG. 4B is a partial side view of the boot of the spark plug wire with the electrical components installed.

FIG. 5 is a section view of the boot of the spark plug at cutline 5-5.

FIG. 6 is a detail view of the boot at area 6-6.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein are made with reference to the views and orientations shown in the exemplary figures. A central axis is shown in the figures and described below. Terms such as “outer” and “inner” are relative to the central axis. For example, an “outer” surface means that the surfaces faces away from the central axis, or is outboard of another “inner” surface. Terms such as “radial,” “diameter,” “circumference,” etc. also are relative to the central axis. The terms “front,” “rear,” “upper” and “lower” designate directions in the drawings to which reference is made and are not to be interpreted as limiting the disclosed concept to the illustrated embodiments or any specific spatial orientation. The terms, connected, attached, etc., refer to directly or indirectly connected, attached, etc., unless otherwise indicated explicitly or by context.

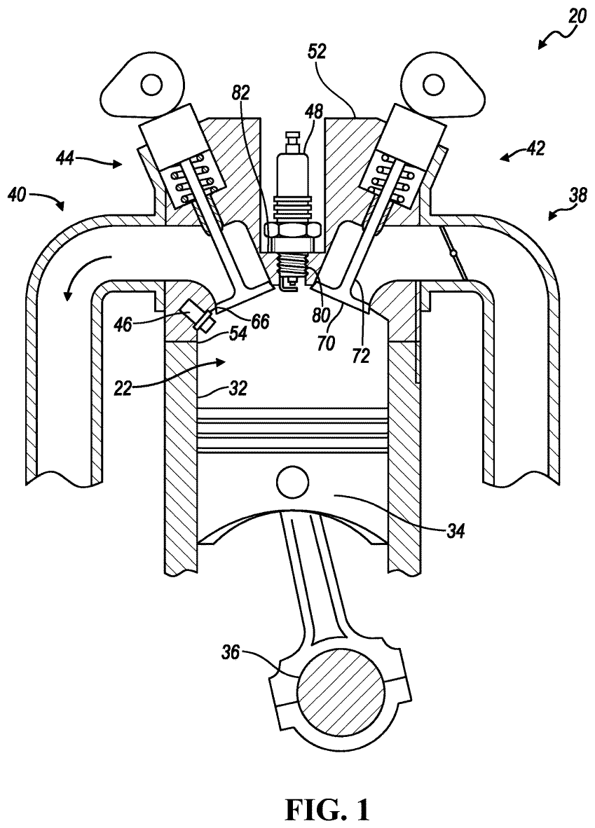

FIG. 1 illustrates a schematic of an internal-combustion engine 20. The engine 20 has a plurality of cylinders 22 (one cylinder is illustrated). The cylinder 22 (also referred to as a combustion chamber) is formed by cylinder walls 32 and a piston 34. The piston 34 is connected to a crankshaft 36. The combustion chamber 22 is in fluid communication with the intake manifold 38 and the exhaust manifold 40. One or more intake valves 42 control flow from the intake manifold 38 into the combustion chamber. One or more exhaust valves 44 control flow from the combustion chamber to the exhaust manifold 40. The intake and exhaust valves 42, 44 are operated to control engine operation. For example, each valve 42, 44 may be mechanically operated by a respective camshaft, or alternatively, may be hydraulically or electrically controlled.

In the illustrated embodiment, the engine 20 has direct injection meaning that the fuel injector 46 delivers fuel directly into the combustion chamber 22. In other embodiments, the engine 20 may include port fuel injection or a combination of both port injection and direct injection.

An ignition system includes a spark plug 48 that is controlled to provide a spark that ignites the fuel-air mixture in the combustion chamber 22. The spark plug 48 may be located in various positions within the combustion chamber 22. The ignition system may further include a power source, e.g., a 12-volt battery, a coil for stepping up voltage for the spark plugs, wires connecting the coils to the spark plug, a control unit, either electronic, e.g., an ECU, or mechanical, e.g., a cap-and-rotor, for controlling spark timing.

The engine 20 includes a controller and various sensors configured to provide signals to the controller for use in controlling the air and fuel delivery to the engine, the ignition timing, valve timing, the power and torque output from the engine, and the like. Engine sensors may include, but are not limited to, an oxygen sensor in the exhaust manifold 40, an engine coolant temperature, an accelerator pedal position sensor, an engine manifold pressure (MAP) sensor, an engine position sensor for crankshaft position, an air mass sensor in the intake manifold 38, a throttle position sensor, and the like.

The cylinder head 52 defines an intake port 60. The intake port 60 provides a passage for flow of intake air or intake gases from the intake manifold 38 to a respective cylinder 22. Intake air may include outside or environmental air, may include fuel mixed therein, and may also be mixed with exhaust gases from an exhaust gas recirculation system, etc. The intake valve 42 seals the port 60 to prevent the flow of intake air into the chamber 22 when the intake valve 42 is in a closed position, and is opened to allow flow of intake air into the chamber 22.

The cylinder head 52 forms a spark plug port 80 that receives the spark plug 48. The spark plug port 80 may be threaded, for example, as a female threaded port. The port 80 extends through the cylinder head 52 such that the spark plug 48 can ignite a fuel-air mixture within the combustion chamber 22. An outer surface of the cylinder head forms a seat 82, and a seal may be formed between the spark plug 48 and the seat 82 to prevent gases from leaving the combustion chamber via the port 80.

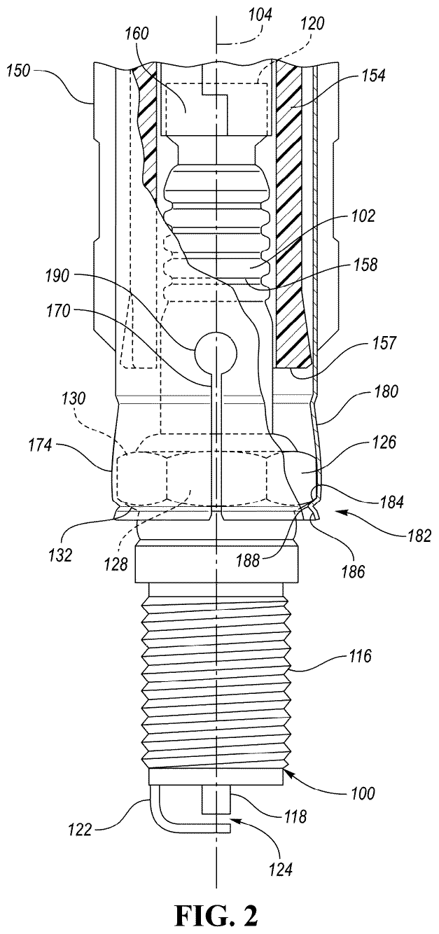

Referring to FIG. 2, a spark plug 100 is illustrated according to an embodiment. The spark plug 100 may be used as the spark plug 48 in the engine 20. The spark plug 100 has an insulator body 102. The insulator body 102 extends along a longitudinal axis 104 from a first end to a second end. The second end of the insulator body 102 may form a tip that extends into the combustion chamber and shields elements of the spark plug 100 from the high-temperature environment of the engine. The insulator body 102 is hollow and defines a passage that extends along the longitudinal axis 104 and through the insulator body 102 from the first end to the second end.

A central electrode 118 is positioned within the passage of the insulator body 102 and extends longitudinally. The central electrode 118 may be a single element, or may include a resistor and one or more springs, as well as an electrode. A terminal 120 is connected to the central electrode 118. The terminal 120 extends out from the first end of the insulator body 102 so that it can connect with a spark-plug wire.

The spark plug 100 also has a side ground electrode 122, or ground strap. The side ground electrode 122 is supported by the insulator body 102. The spark plug 100 may be provided with a single side ground electrode 122 as shown. In other examples, the spark plug 100 may have more than one side ground electrode 122. An electrode gap 124 is formed between the side ground electrode 122 and the end of the central electrode 118. In use, the side ground electrode 122 is electrically grounded by the cylinder head 52, while central electrode 118 is electrically isolated from the ground side electrode 122 via the insulator body 102. A gap 124 is formed between the end of the central electrode 118 and the side ground electrode 122. When the central electrode 118 is supplied with sufficient voltage and current, electrical current crosses or jumps the gap 124 between the central electrode 118 and the side ground electrode 122, creating a spark that ignites the air-fuel mixture within the combustion chamber.

The spark plug 100 includes male threads 116 configured to threadably engage with the female threads formed in the cylinder head. A hex 126 is provided for screwing the spark plug 100 into the cylinder head. The hex 126 includes flat faces 128, e.g., six faces, formed on the circumference of the hex 126 and front and backsides 130, 132.

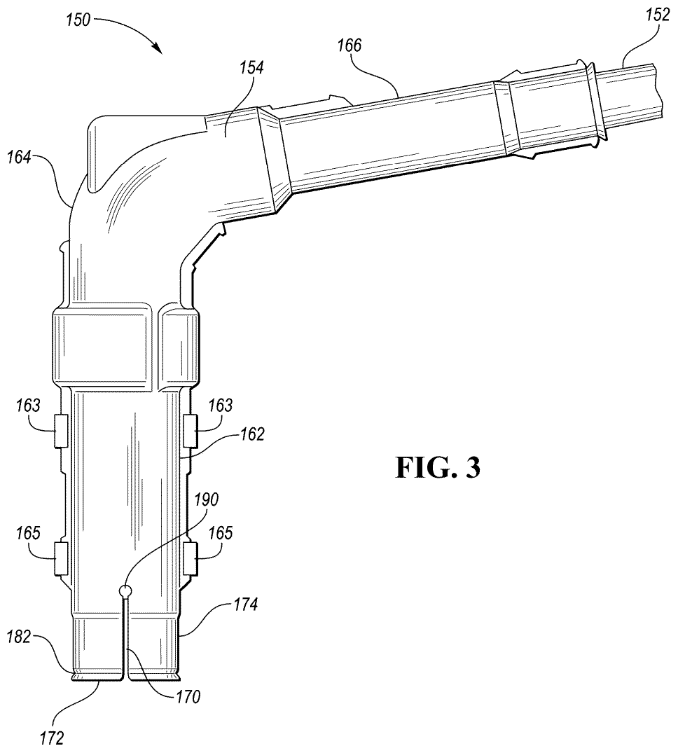

Referring to FIGS. 2 and 3, a spark-plug wire 150 connects the spark plug 100 to the ignition system. The wire 150 includes a boot 154 configured to be received on an upper portion of the spark plug and an electrical cable 152 that connects between the boot and the ignition system. The boot 154 is formed of the electrically insulating material, e.g., rubber. The boot 154 defines a bore configured to receive an upper ceramic portion 158 of the spark plug. The spark-plug wire 150 is configured to provide electrical voltage and current to the spark plug.

Disposed within the boot 154 is an electrical connector (terminal) 160 configured to mechanically and electrically connect to the terminal 120 of the spark plug 100. The electrical connector 160 is electrically connected to the cable or wire 152 so that electric current and voltage can be provided to the spark plug 100 from the coil of the ignition system. The connector 160 is designed to mechanically couple the terminal 120 such that a retaining force is provided. The electrical connector 160 may provide the retaining force to secure the wire and boot to the spark plug. For example, the spark-plug wire electrical connector 160 may have dimples facing inward. The dimples are resilient and can flex radially to expand over the spark plug terminal 120 during installation. The natural radially inward bias of the dimples rest in a reduced diameter channel in the terminal 120. This creates a retention force against the spark plug terminal 120. As will be explained in more detail below, the spark-plug wire 150 may have further retentions features in addition to this retention at the connector 160.

Spark plugs frequently extend from the cylinder heads at locations that are hot. For example, the spark plugs may extend between runners of the exhaust manifold. The spark-plug wire 150 includes a heat shield 162 to protect the electrical components and the boot. The heat shield 162 is generally cylindrical and circumscribes the boot 154. In the illustrated embodiment, the heat shield 162 is L-shaped and includes a first portion 164 received around the boot 154 and a second portion 166 received around a lower portion of the electrical cable 152. The heat shield 162 may be formed of metal. The heat shield 162 is secured to the boot 154 by one or more sets of clips. In the illustrated embodiment, a pair of clips 163 and 165 are used. However, in other embodiments, only a single set of clips may be used. Alternatively, three sets of clips may be used.

The retaining force provided by the terminal 120 is limited in some instances and may be insufficient to robustly secure the spark-plug wires 150 to the spark plugs. Disclosed herein, is an improved heat shield 162 that is longer to project past the boot and includes retaining features that supplement the terminal 120. The retaining features are configured to grip the hex 126 of the spark plug 100 to provide additional retention force.

In the illustrated embodiment, the heat shield 162 includes a plurality of slots 170 that extend longitudinally from a distal end 172 of the heat shield. The slots 170 define retaining features (e.g., gripping claws 174) configured to engage with the hex 126. The gripping claws 174 may be integrally formed with the heat shield 162. In the illustrated embodiment, the heat shield 162 includes four slots 170 to form four gripping claws 174. Of course, this is just one example and the heat shield may include more or less gripping claws in other embodiments.

The gripping claws 174 extend past the distal end 157 of the boot 154. In the illustrated embodiment, the gripping claws 174 begin roughly at the distal end 157 and extend towards the spark plug. The gripping claws 174 have a length sufficient to extend slightly past the hex 126 of the spark plug 100 when the wire 150 is installed. This allows the gripping claws 174 to snap-fit and grip to the backside 132 of the hex 126.

Each of the gripping claws 174 has a sidewall 180 defining a notch 182 extending radially inward. The notch 182 is arranged to extend circumferentially along the width of the gripping claws 174. In some embodiments, the notch 182 may circumferentially expand the entire width or may be partial. The notch 182 has an inwardly extending retaining surface 184 configured to engage with the backside 132 of the hex 126 and an outwardly extending guide surface 186 configured to facilitate installation of the gripping claws 174 over the hex 126. The notch 182 is generally V-shaped in the illustrated embodiment. As shown, the retaining surface 184 extends radially inward at an oblique angle from a main portion of the sidewall 180. The guide surface 186 extends radially outward from an end of the retaining surface 184 (which is also the vertex of the notch) at an oblique angle. The angle of the retaining surface 184 may be steeper (more perpendicular relative to the centerline 104) than the guide surface 186. The vertex of the retaining surface 184 and the guide surface 186 form a ridge or innermost portion of the notch 182.

In aggregate, the ridges of the notches 182 define an intermittent circumferentially extending projection 188 of the heat shield 162. The projection 188 has a resting diameter that is smaller than the diameter of the hex 126. The gripping claws 174 are resilient and can flex radially to permit the heat shield 162 to be installed over the hex 126. During installation, the guide surfaces 186 act as ramps causing the gripping claws 174 to deflect radially outward. Once the notches 182 clear the backside 132 of the hex 126, the natural radially inward bias of the gripping claws 174 snap-fit to the hex 126 with the projection 188 hooking over the backside 132 of the hex 126 and with the retaining surfaces 184 disposed mostly against the backside 132. Since the diameter of the projection 188 is less than the hex 126, interference is present to retain the spark-plug wire 150 to the spark plug 100 and create a retention force. The spark-plug wire 150 may be removed from the spark plug 100 by applying a pulling force that exceeds the retention force of the gripping claws 174, thus causing the gripping claws 174 to deflect radially outward to allow removal.

To increase the flexibility of the gripping claws 174, one or more of the slots 170 may include an associated circular hole 190. The circular hole 190 is located at an end of the slot 170 such that the slot and the hole are continuous. The circular hole 190 may only be provided with some of the slots 170. For example, the heat shield 162 may include four slots 170 with only two of the slots including an associated circular hole 190. The two slots that have the associated hole may be diametrically opposite each other.

The heat shield 162 protects the spark-plug wire from engine heat and increases the retention force that retains the spark-plug wire 150 to the spark plug. The additional retention force of the heat-shield retaining features 174 in conjunction with the traditional electrical connector 160 disposed in the boot 154 to reduce the likelihood of the spark-plug wire 150 inadvertently disconnecting from the spark plug 100 during both manufacturing of the vehicle and road use.

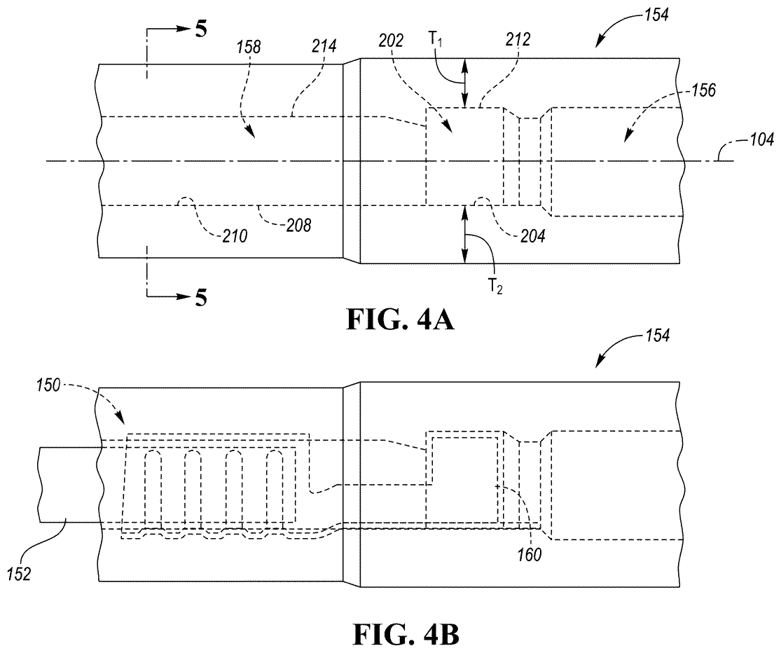

FIGS. 4A and 4B illustrate the internals of the boot 154 in more detail. The boot 154 includes a centerline (also known as a central axis) 104. Within the boot 154 are a plurality of bores, chambers, and void spaces some of which are concentric with the centerline 104 and others that are eccentric relative to the centerline 104. These bores, chambers, void spaces are in communication such that the boot 154 is hollow throughout the entire interior. For example, the boot 154 may define a spark-plug bore 156 configured to receive the spark plug 100 therein. Opposite the bore 156 is a wire bore 158 configured to receive the wire or cable 152. The bores 156, 158 are concentric with the centerline 104 in the illustrated embodiment. However, in other embodiments, the bores may be eccentric relative to the centerline 104.

A terminal pocket 202 is defined within the boot 154 and is located between the wire bore 158 and the spark-plug bore 156. The terminal pocket 202 is a void space within the boot 154 sized and shaped to house the terminal 160 that connects with the terminal 120 of the spark plug 100. The terminal pocket 202 is eccentric relative to the central axis 104 and consequently is also eccentric relative to the bores 156, 158. This eccentricity causes the sidewall thickness of the boot 154 to vary at the terminal pocket 202. That is, the boot 154 is thicker or thinner at different circumferential position around the central axis 104. As shown in FIG. 4A, the thickness T1 is less than the thickness T2. The boot 154 may be designed with the thicker portion T2 facing the hotter side of the engine, e.g., adjacent to the exhaust manifold, to provide greater thermal insulation.

At certain circumferential positions of the boot 154 about the central axis 104, a portion 204 of the sidewall 206 of the terminal pocket 202 has a same radial position as a portion 208 of the sidewall 210 of the wire bore 158. As best shown in FIG. 4A, the portions 208 and 204 form a continuous circumferential wall and share a tangent. However, due to the eccentricity of the terminal pocket 202 other portions of the sidewalls 206, 210 have different radial positions relative to the central axis 104. For example, the portion 212 of the terminal pocket 202 is spaced farther away from the centerline 104 than a portion 214 of the wire bore 158.

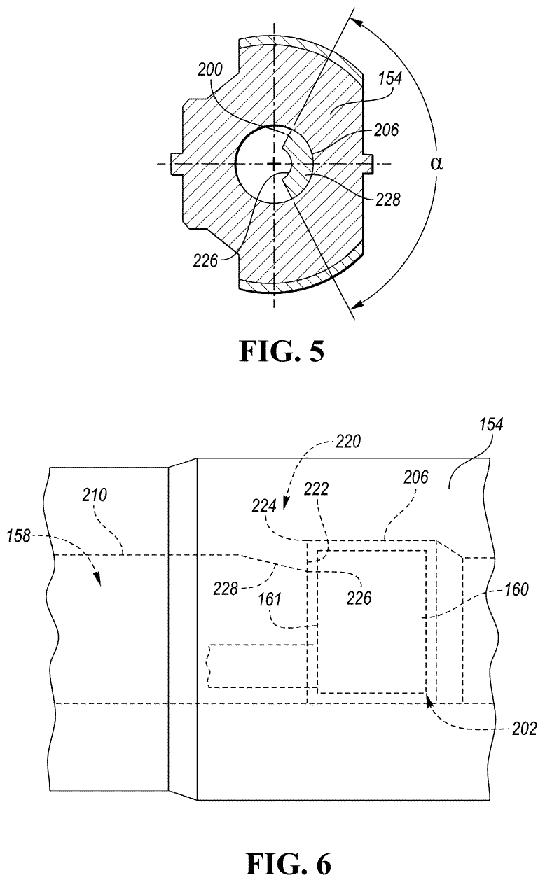

Referring to FIG. 4A through FIG. 6, the boot 154 includes a retainer 220 that secures the terminal 160 within the terminal pocket 202. The retainer 220 may be an integrally formed portion of the boot 154. The retainer 220 is longitudinally positioned on the backside of the terminal pocket 202 near the entrance of the wire bore 158. The retainer 220 has a radially extending wall 222 having an outboard end 224 that intersects with the sidewall 206 of the terminal pocket and an inboard end 226 that terminates in space within the terminal pocket 202. The inboard end 226 may be circular having a circumferential inner-most surface as best seen in FIG. 5, e.g., a circular notch concentric with the central axis 104. The radially extending wall 222 only circumferentially extends partially around wire bore 158. For example, as shown in FIG. 6, the retainer 220 is present at the top but not the bottom of the terminal pocket 202 and wire bore 158. The retainer 220 may have an arc length, alpha, that extends between 60 and 180 degrees. In other embodiments, the arc length may be between 90 and 150 degrees.

A conical or frustoconical surface 228 extends from the inboard end 226 to the sidewall 210 of the wire bore 158. A radial distance between the inboard end 226 and the sidewall 206 of the terminal pocket 202 is greater than a radial distance between the inboard end 226 and the sidewall 210 of the wire bore 158.

The radial wall 222 of the retainer 220 is configured to engage with a backside 161 of the terminal 160 to inhibit movement of the terminal 160. That is, the radial wall 222 inhibits the terminal 160 from moving towards the wire bore 158 due to forces from the spark plug when the wire is connected thereto. The retainer 220 may also aid in properly seating the terminal 160 within the terminal pocket 202 during manufacturing when the boot is installed on the wire.

The above-described sizing and geometries of the retainer are exemplary, and the retainer may have any size and shape capable of retaining the terminal in the terminal pocket while providing sufficient clearance to allow the terminal and wire to extend from the terminal pocket to the wire bore. Additional examples include rectangular or square retainers or straight sided retainers with a circular-notched inboard wall to increase clearance.

In some embodiments, the length of the boot and gripping claws are selected such that the gripping claws snap over the hex head simultaneously with the spark-plug terminal connecting with the wire terminal within the boot. This may provide the installer better tactile feedback to ensure the spark-plug wire terminal has been correctly connected and seated on the spark-plug terminal. This may be accomplished by shorting the boot compared to traditional designs.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A spark-plug wire comprising:
a boot of electrically insulating material including:
a wire bore,
a spark-plug bore defining a terminal pocket adjacent to an end of the wire bore, and
a retainer extending radially inward from a sidewall of the wire bore and defining a radial wall of the terminal pocket;
a terminal disposed in the terminal pocket and configured to connect with a spark plug when received in the spark-plug bore, wherein the radial wall of the retainer is configured to engage with the terminal to inhibit movement of the terminal; and
a wire disposed in the wire bore and electrically connected to the terminal.

2. The spark-plug wire of claim 1, wherein the retainer includes a conical surface extending from an inboard end of the radial wall to the sidewall of wire bore.

3. The spark-plug wire of claim 2, wherein a radial distance between the inboard end and a sidewall of the terminal pocket is greater than a radial distance between the inboard end and the sidewall of the wire bore.

4. The spark-plug wire of claim 1, wherein the terminal pocket is eccentric relative to the wire bore.

5. The spark-plug wire of claim 4, wherein a portion of the sidewall of the wire bore is continuous with a portion of a sidewall of the terminal pocket.

6. The spark-plug wire of claim 4, wherein the terminal pocket is eccentric relative to a central axis of the boot to increase a thickness of the electrically insulating material on a portion of the boot.

7. The spark-plug wire of claim 6, wherein the spark-plug bore is concentric with the central axis of the boot, wherein the terminal pocket is disposed between the wire bore and the spark-plug bore.

8. The spark-plug wire of claim 7, wherein a side of the terminal is disposed against the radial wall.

9. The spark-plug wire of claim 1, wherein the retainer is formed of the electrically insulative material.

10. The spark-plug wire of claim 1 further comprising a heat shield received on the boot.

11. The spark-plug wire of claim 10, wherein the heat shield includes a two pairs of clamping tabs configured to secure the heat shield to the boot.

12. A spark-plug wire comprising:
a boot defining a terminal pocket; and
a wire extending into the boot and including a terminal disposed within the terminal pocket, wherein the terminal pocket includes a radially extending wall configured to engage with the terminal to inhibit movement of the terminal, wherein the radially extending wall circumferentially extends less than 180 degrees around the terminal pocket.

13. The spark-plug wire of claim 12, wherein the boot further defines a bore that receives the wire therein, wherein the radially extending wall separates the bore and the terminal pocket.

14. The spark-plug wire of claim 13 further comprising a conical surface extending from an inboard end of the radially extending wall to a sidewall of the bore.

15. The spark-plug wire of claim 12, wherein the radially extending wall is integrally formed with the boot.

16. The spark-plug wire of claim 12, wherein the terminal pocket is eccentric relative to a central axis of the boot.

17. A vehicle ignition system comprising:
a spark-plug wire including:
a boot of electrically insulating material having a wire bore and a spark-plug bore defining a terminal pocket adjacent to an end of the wire bore,
a retainer extending radially inward from a sidewall of the wire bore and defining a radial wall,
a terminal disposed in the terminal pocket, wherein the radial wall of the retainer is configured to engage with the terminal to inhibit movement of the terminal, and
a wire disposed in the wire bore and electrically connected to the terminal; and
a spark plug received in the spark-plug bore and connected to the terminal.

18. The vehicle ignition system of claim 17, wherein the retainer includes a conical surface extending from an inboard end of the radial wall to the sidewall of wire bore.

19. The vehicle ignition system of claim 18, wherein a radial distance between the inboard end and a sidewall of the terminal pocket is greater than a radial between the inboard end and the sidewall of the wire bore.

20. The vehicle ignition system of claim 17, wherein the terminal pocket is eccentric relative to the wire bore.
